(19) United States
(12) Patent Application Publication
(10) Pub. No.: US 2024/0311652 A1
(43) Pub. Date: Sep. 19, 2024

(54) Markup Language for Generative Model Prompting

(71) Applicant: Google LLC, Mountain View, CA (US)

(72) Inventors: Chinmay Kulkarni, Atlanta, GA (US); Alexander John Fiannaca, Seattle, WA (US); Michael Andrew Terry, Cambridge, MA (US)

(21) Appl. No.: 18/183,429

(22) Filed: Mar. 14, 2023

(51) Int. Cl. G06N 3/10; G06N 3/0475; G06N 3/08

(52) U.S. Cl. CPC G06N 3/10; G06N 3/0475; G06N 3/08

(57) ABSTRACT

Systems and methods for prompt generation for generative models can include utilizing a specialized markup language. A markup language transform can be utilized to augment user input data to generate a prompt that includes structure and/or wording that facilitates the generation of a generative output that reflects a user's intent. The systems and methods can leverage the specialized markup language and/or an integrated development environment interface to inform a user of the prompt parts and provide editing options.

### FIELD

The present disclosure relates generally to a markup language interface for generative model prompting. More particularly, the present disclosure relates to systems and methods that leverage a specialized markup language interface for generating prompts for generative models.

### BACKGROUND

Users can experience difficulty in writing prompts for large language models, because prompt crafting can be difficult for non-experts as they have to know all the parts necessary for good results. Prompt crafting can be unintuitive. Additionally, prompts crafted without a particular structure, terminology, and/or weighting may lead to outputs that do not reflect the intent of the user. Determining the issues and problem solving for instances in which a less than desirable output is generated can be increasingly difficult. The knowledge and experience gap can be vast and can cause a hurdle for new users in using generative models.

### SUMMARY

Aspects and advantages of embodiments of the present disclosure will be set forth in part in the following description, or can be learned from the description, or can be learned through practice of the embodiments.

One example aspect of the present disclosure is directed to a computing system. The system can include one or more processors and one or more non-transitory computer-readable media that collectively store instructions that, when executed by the one or more processors, cause the computing system to perform operations. The operations can include providing a user interface to a user computing system. The user interface can include an integrated development environment. The operations can include obtaining a plurality of input characters from the user computing system via the user interface. The plurality of input characters can be descriptive of a user prompt request. The operations can include processing the plurality of input characters to determine an intent of the user prompt request. The operations can include generating a refined prompt based on performing a mark-up language transform on the plurality of input characters and the intent and providing the refined prompt to a generative model to receive a generative output.

In some implementations, the operations can include receiving the generative output from the generative model and providing the generative output to the user computing system. The operations can include processing the plurality of input characters to determine a plurality of text tokens associated with a plurality of input character sets determined to be semantically linked and providing a plurality of respective token indicators associated with at least a subset of the plurality of text tokens. Each respective token indicator can include a graphical indicator indicating a length and location of a respective text token. In some implementations, the integrated development environment can be configured to receive the plurality of input characters and is configured to perform the mark-up language transform. The integrated development environment can be associated with prompt-generation mark-up language. In some implementations, the prompt-generation mark-up language can include one or more delimiters selected based on a determined low likelihood of use in traditional natural language. The integrated development environment can be associated with a text-encoding system associated with a set of pre-determined symbols associated with a set of formatting operators. In some implementations, the refined prompt can include a preamble associated with a specified task. The refined prompt can include a body associated with one or more details to include in the generative output. In some implementations, the operations can include determining one or more prompt term suggestions based on the intent and providing the one or more prompt term suggestions as selectable user interface elements.

Another example aspect of the present disclosure is directed to a computer-implemented method for prompt generation. The method can include providing, by a computing system including one or more processors, a user interface to a user computing system. The user interface can include an integrated development environment. The method can include obtaining, by the computing system, a plurality of input characters from the user computing system via the user interface. The plurality of input characters can be descriptive of a user prompt request. The method can include processing, by the computing system, the plurality of input characters to determine one or more prompt term suggestions. The method can include providing, by the computing system, one or more selectable user interface elements to the user computing system via the user interface. In some implementations, the one or more selectable user interface elements can be associated with the one or more prompt term suggestions. The method can include receiving, by the computing system, a selection input descriptive of a selection of a selected prompt term suggestion associated with a selected user interface element of the one or more selectable user interface elements. The method can include generating, by the computing system, a refined prompt based on performing a mark-up language transform on the plurality of input characters and the selected prompt term suggestion. The method can include providing, by the computing system, the refined prompt to a generative model to receive a generative output.

In some implementations, the one or more prompt term suggestions can be determined based on a determined intent of the prompt request. The determined intent can be determined based on processing at least a subset of the plurality of input characters. In some implementations, the one or more prompt term suggestions can be obtained from an index of prompt terms. The index of prompt terms may have been generated based on historical prompt data associated with historical content generation. In some implementations, the index of prompt terms may have been generated based on one or more training labels associated with the training dataset for the generative model. The plurality of input characters can include a first structure. The refined prompt can include a second structure.

Another example aspect of the present disclosure is directed to one or more non-transitory computer-readable media that collectively store instructions that, when executed by one or more computing devices, cause the one or more computing devices to perform operations. The operations can include providing a user interface to a user computing system. The user interface can include an integrated development environment. In some implementations, the integrated development environment can be associated with a specialized mark-up language for prompt generation. The operations can include obtaining preliminary prompt including a plurality of input characters from the user computing system via the user interface. The plurality of input characters can be descriptive of a user prompt request. The operations can include processing the plurality of input characters to determine an intent of the user prompt request. The operations can include generating a refined prompt based on performing a mark-up language transform and based on the preliminary prompt and the intent. The operations can include providing the refined prompt to a generative model to receive a generative output.

In some implementations, the plurality of input characters can be descriptive of a subject and one or more details to include in a generated subject. The refined prompt can include a restructured text string descriptive of a predetermined style. The refined prompt can be descriptive of the subject and the one or more details. In some implementations, generating the refined prompt can include word mapping. A subset of the plurality of input characters can be mapped to one or more alternate words. In some implementations, generating the refined prompt can include structure mapping. A subset of the plurality of input characters can be mapped to a predefined structure associated with a preamble and a body of the refined prompt.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs prompt generation according to example embodiments of the present disclosure.

FIG. 1B depicts a block diagram of an example computing device that performs prompt generation according to example embodiments of the present disclosure.

FIG. 1C depicts a block diagram of an example computing device that performs prompt generation according to example embodiments of the present disclosure.

FIG. 2 depicts a block diagram of an example prompt generation based on markup language transform according to example embodiments of the present disclosure.

FIG. 3 depicts an illustration of an example prompt term suggestion interface according to example embodiments of the present disclosure.

FIG. 4 depicts an illustration of an example prompt template interface according to example embodiments of the present disclosure.

FIG. 5 depicts an illustration of example token indicators according to example embodiments of the present disclosure.

FIG. 6 depicts a flow chart diagram of an example method to perform prompt generation based on intent and markup language transform according to example embodiments of the present disclosure.

FIG. 7 depicts a flow chart diagram of an example method to perform prompt generation based on prompt term suggestion and markup language transform according to example embodiments of the present disclosure.

FIG. 8 depicts a flow chart diagram of an example method to perform prompt generation according to example embodiments of the present disclosure.

FIG. 9 depicts an illustration of an example autocompletion suggestion according to example embodiments of the present disclosure.

FIG. 10 depicts an illustration of an example prompt writer interface according to example embodiments of the present disclosure.

FIG. 11 depicts an illustration of an example prompt programming user interface experience according to example embodiments of the present disclosure.

FIG. 12 depicts an illustration of an example dropdown interface element according to example embodiments of the present disclosure.

Reference numerals that are repeated across plural figures are intended to identify the same features in various implementations.

### DETAILED DESCRIPTION

### Overview

Generally, the present disclosure is directed to systems and methods for utilizing a specialized markup language for generative model prompting (e.g., large language model prompting). In particular, the systems and methods disclosed herein can leverage a specialized markup language and/or a specialized user interface to generate refined prompts without relying on user knowledge. For example, the systems and methods can provide an interface that receives natural language inputs and/or one or more markup language syntax and outputs a refined prompt that can include a particular structure and/or particular wording.

Crafting prompts for large language models and/or other generative models (e.g., generative image models) can be difficult. The sequence weighting, tokenization, and/or terminology in prompt generation may be unintuitive. For example, the location of a word in a text string may be associated with a given weight during processing. Additionally and/or alternatively, the understood grouping of characters may lead to different interpretations. In some implementations, even the terminology utilized may have varying levels of meaning for a generative model despite being viewed as analogous to an individual. The misunderstandings and/or lack of knowledge of the user can lead to unintended outcomes, poor generative outputs, and/or a null output.

The use of a specialized markup language can enable a markup language transform that generates a refined prompt that leverages known weighting techniques and terminology to generate a prompt that captures an intent of a user. Additionally and/or alternatively, the integrated development environment can be utilized to receive inputs and provide indicators of identified tokens, errors, labels, etc. In some implementations, the systems and methods can include determining and providing for selection one or more prompt term suggestions. The interface elements paired with the specialized markup language can allow unversed users to generate refined prompts with detailed terms and particularized structure that can be utilized to retrieve generative outputs that encapsulate a user's intent. Additionally and/or alternatively, the editing features disclosed herein can be utilized to identify issues and augment an input and/or a response. In some implementations, a user may specify weights and/or imply a preference. For example, in some implementations, a determined user intent, a specified weight, and/or an implied preference may be processed to determine weighting to include in the refined prompt. Additionally and/or alternatively, parameters (e.g., different temperatures for a lambda model, model-specific parameters, and/or top-end possible generations) may be determined based on one or more determinations and/or one or more explicit inputs. In some implementations, “distracting” language, article adjectives, and/or terms that may not be utilized by and/or may confuse the model may be stripped from the prompt.

The systems and methods can include providing a user interface to a user computing system. The user interface can include an integrated development environment. The systems and methods can include obtaining a plurality of input characters from the user computing system via the user interface. The plurality of input characters can be descriptive of a user prompt request. The systems and methods can include processing the plurality of input characters to determine an intent of the user prompt request. The systems and methods can include generating a refined prompt based on performing a markup language transform on the plurality of input characters and the intent. The systems and methods can include providing the refined prompt to a generative model to receive a generative output.

For example, the systems and methods can provide a user interface to a user computing system. The user interface can include an integrated development environment. The integrated development environment can be configured to receive a plurality of input characters. Additionally and/or alternatively, the integrated development environment can be configured to perform the markup language transform. In some implementations, the integrated development environment can be associated with prompt-generation markup language. The prompt-generation markup language can include one or more delimiters selected based on a determined low likelihood that the symbol will be utilized during prompt input and/or traditional natural language input (e.g., low likelihood of use in a natural language prompt input by one or more users). Additionally and/or alternatively, the integrated development environment can be associated with a text-encoding system associated with a set of pre-determined symbols associated with a set of formatting operators.

A plurality of input characters can then be obtained from the user computing system via the user interface. The plurality of input characters can be descriptive of a user prompt request. The plurality of input characters can be descriptive of a natural language text string. Alternatively and/or additionally, the plurality of input characters can include one or more syntax symbols. The syntax symbols may be associated with functions of the prompt-generation markup language and/or may be natural language syntax that may denote traditional syntactical use. In some implementations, the plurality of input characters can be descriptive of a plurality of words and/or a plurality of separators (e.g., spaces, commas, periods, slashes, etc.).

The plurality of input characters can be processed to determine an intent of the user prompt request. The processing can include parsing the plurality of input characters to segment one or more words, one or more phrases, and/or one or more other text string segments. The parsed segments may be processed to determine individual segment intents. The individual segment intents can then be processed to determine an overall intent. Alternatively and/or additionally, the plurality of input characters may be processed as a whole to determine the intent. In some implementations, one or more other processing techniques may be utilized to determine intent. Intent determination can include processing with one or more models (e.g., a semantic understanding model, a segmentation model, a detection model, a sentiment model, and/or a classification model). The intent can be associated with a determined portion of the user input that is associated with a task for the generative model to perform and/or a context for the generative model. Additionally and/or alternatively, the intent can be associated with a determined portion of the user input associated with an input/output example.

A refined prompt can then be generated based on performing a markup language transform on the plurality of input characters and the intent. In some implementations, the refined prompt can include a preamble associated with a specified task. The refined prompt may include a body associated with one or more details to include in the generative output. In some implementations, the refined prompt can include weights, a specific structure associated with a subject and one or more details, and/or one or more parameters for selecting a particular model, a particular temperature, and/or a particular template.

The systems and methods can then provide the refined prompt to a generative model to receive a generative output. The generative model can include one or more transformer models. The generative model can include a diffusion model and/or an autoregressive language model. In some implementations, the generative model can be trained to process a prompt and generate one or more content outputs. The one or more content outputs can include text (e.g., a natural language response), one or more images (e.g., a generated image of the described prompt), an audio file, a video, statistical data, latent encoding data, and/or other signal data.

In some implementations, the systems and methods can receive the generative output from the generative model and provide the generative output to the user computing system. The generative output may be displayed in the user interface. The generative output may be provided in a preview window of the integrated development environment, in line and/or following the prompt in the integrated development environment, and/or in a separate window. In some implementations, the generative output may be provided with an annotated refined prompt and/or an annotated plurality of input characters. The annotations can be descriptive of tokenization, determined intent, usage of the characters, and/or one or more options for editing. In some implementations, the generative output may replace the integrated development environment.

Additionally and/or alternatively, the systems and methods can process the plurality of input characters to determine a plurality of text tokens associated with a plurality of input character sets determined to be semantically linked and provide a plurality of respective token indicators associated with at least a subset of the plurality of text tokens. In some implementations, the text token determination can be performed by one or more machine-learned models (e.g., one or more language models (e.g., one or more natural language processing models), one or more segmentation models, and/or one or more semantic analysis models). Each respective token indicator can include a graphical indicator indicating a length and location of a respective text token. The one or more graphical indicators may be utilized to determine how the text string is processed and may be utilized for problem solving (e.g., determining that semantically linked words were not processed cohesively during the prompt processing (e.g., “snow crab” may have been processed as individual words instead of as a whole)).

In some implementations, the systems and methods can determine one or more prompt term suggestions based on the intent and can provide the one or more prompt term suggestions as selectable user interface elements. The one or more prompt term suggestions may be based on one or more natural language processing models processing the input characters to provide outputs descriptive of an autocompletion task and/or a semantic analysis task. The prompt term suggestions may be machine-learned model outputs and/or may be retrieved from an index of prompt terms. The index may be based on the training data of the generative model. Alternatively and/or additionally, the index may be generated based on historical data associated with the generative model and/or the specific user. For example, terms that lead to a desired result may be determined and stored, while terms that may be determined as often replaced in iterative prompt inputs may be not included and/or may be annotated in the index to replace if provided by the user. The index may be based on past usage by the user and/or may be based on other user data (e.g., search history, browsing history, messaging history, user profile data, news proximate to the user, and/or predictive data associated with the user).

The systems and methods can include one or more user interface features that provide suggestions to the user to refine a prompt and/or to direct a user to specific terms associated with a determined intent and/or topic. The systems and methods can include providing a user interface to a user computing system. The user interface can include an integrated development environment. A plurality of input characters can be obtained from the user computing system via the user interface. In some implementations, the plurality of input characters can be descriptive of a user prompt request. The systems and methods can include processing the plurality of input characters to determine one or more prompt term suggestions. The one or more prompt term suggestions can be based on heuristics, an index of known effective prompts, an index of prompt templates, a learned pattern, an output of a machine-learned model (e.g., a natural language processing model), and/or sequence data. One or more selectable user interface elements can then be provided to the user computing system via the user interface. The one or more selectable user interface elements can be associated with the one or more prompt term suggestions. The systems and methods can include receiving a selection input descriptive of a selection of a selected prompt term suggestion associated with a selected user interface element of the one or more selectable user interface elements. A refined prompt can be generated based on performing a markup language transform on the plurality of input characters and the selected prompt term suggestion. The systems and methods can include providing the refined prompt to a generative model to receive a generative output.

The systems and methods can provide a user interface to a user computing system. The user interface can include an integrated development environment. The user interface can be configured to display input data, a generated refined prompt, one or more user interface elements (e.g., one or more indicators and/or one or more annotations), and/or one or more generative outputs. The user interface may include multiple display windows to display multiple content types. In some implementations, the integrated development environment can include line numbering, space formatting, color notations, drop-down windows, and/or a table of functions or operators. The user interface can include a text input box. Additionally and/or alternatively, the user interface can include an integrated development environment that can receive text inputs, provide suggestions, provide token indicators, provide previews, and/or provide autocorrections. The user interface can be configured to process text and visually display the determined semantic parts of the input text.

A plurality of input characters can be obtained from the user computing system via the user interface. In some implementations, the plurality of input characters can be descriptive of a user prompt request. The prompt request may be descriptive of one or more subjects (e.g., one or more environments and/or one or more objects) and/or one or more details for the one or more subjects (e.g., one or more descriptors, which can include adjectives, adverbs, genre descriptors, aesthetic descriptors, color descriptors, culture descriptors, etc.).

The plurality of input characters can be processed to determine one or more prompt term suggestions. The one or more prompt term suggestions can be determined based on a determined intent of the prompt request. The determined intent can be determined based on processing at least a subset of the plurality of input characters. In some implementations, the one or more prompt term suggestions can be obtained from an index of prompt terms. The index of prompt terms may have been generated based on historical prompt data associated with historical content generation. Alternatively and/or additionally, the index of prompt terms may have been generated based on one or more training labels associated with the training dataset for the generative model.

One or more selectable user interface elements can then be provided to the user computing system via the user interface. The one or more selectable user interface elements can be associated with the one or more prompt term suggestions. The one or more selectable user interface elements can include inline text and/or may be provided via a drop-down menu, a bubble, and/or a pop-up.

The systems and methods can receive a selection input descriptive of a selection of a selected prompt term suggestion associated with a selected user interface element of the one or more selectable user interface elements. The selection input can include a gesture input, a key selection (e.g., “tab”), a touch selection, and/or a mouse selection.

A refined prompt can then be generated based on performing a markup language transform on the plurality of input characters and the selected prompt term suggestion. In some implementations, the plurality of input characters can include a first structure. The refined prompt can include a second structure.

The refined prompt can then be provided to a generative model to receive a generative output. The refined prompt may include natural language text, a language embedding. and/or multimodal data. The generative model can include a text-to-text model, a text-to-image model, a text-to-audio model, and/or another generative model. The prompt request and/or the generative output may include multimodal data (e.g., text data, image data, and/or audio data).

The systems and methods can leverage a specialized markup language for prompt generation. For example, the systems and methods can include providing a user interface to a user computing system. The user interface can include an integrated development environment. The integrated development environment can be associated with a specialized markup language for prompt generation. The systems and methods can include obtaining a preliminary prompt including a plurality of input characters from the user computing system via the user interface. The plurality of input characters can be descriptive of a user prompt request. The plurality of input characters can be processed to determine an intent of the user prompt request. A refined prompt can then be generated based on performing a markup language transform and based on the plurality of input characters and the intent. The systems and methods can include providing the refined prompt to a generative model to receive a generative output.

A user interface can be provided to a user computing system. The user interface can include an integrated development environment. The integrated development environment can be associated with a specialized markup language for prompt generation. The specialized markup language may be denoted as a prompt generation markup language. The specialized markup language can include delimiters that do not traditionally appear in natural language text strings. Additionally and/or alternatively, the specialized markup language can include operators that do not traditionally appear in natural language text strings. The specialized markup language can include operators for separation, weighting, classification, notification, parameter specification, and/or priority notations.

A preliminary prompt including a plurality of input characters can then be obtained from the user computing system via the user interface. In some implementations, the plurality of input characters can be descriptive of a user prompt request. The plurality of input characters can be descriptive of a subject and one or more details to include in a generated subject. The prompt request can be associated with a specific generative model, a specific temperature, a specific genre, a specific parameter setting, a specific use or vocabulary, and/or a specific particularity.

The plurality of input characters can then be processed to determine an intent of the user prompt request. The intent can be determined based on a top-down approach, a bottom-up approach, a series processing of the individual parts and the whole simultaneously, and/or context data. The intent can be descriptive of a theme, genre, type of output, and/or an overall environment.

A refined prompt can be generated based on performing a markup language transform and based on the preliminary prompt and the intent. In some implementations, the refined prompt can include a restructured text string descriptive of a predetermined style. Additionally and/or alternatively, the refined prompt can be descriptive of the subject and the one or more details. Generating the refined prompt can include word mapping. A subset of the plurality of input characters may be mapped to one or more alternate words. Additionally and/or alternatively, generating the refined prompt can include structure mapping. A subset of the plurality of input characters may be mapped to a predefined structure associated with a preamble and a body of the refined prompt.

The refined prompt can then be provided to a generative model to receive a generative output. The generative model can be a large language model and/or an image generative model. The generative output can include text data, image data, audio data, embedding data, video data, and/or multimodal data.

The systems and methods disclosed herein can include one or more features for prompt annotation, prompt generation, prompt augmentation, prompt editing, and/or prompt completion. For example, the systems and methods may include prompt term suggestion, prompt templates, displayed tokenization, autocomplete, prompt feedback interfaces, pattern recognition and suggestion, prompt reformulation, prompt embedding manipulation, error recognition, snippet library, and/or expressive prompt language indication.

The prompt term suggestion can include automatically suggesting contextually appropriate clauses to insert into a prompt. In the context of text-to-image model prompting, many short phrases may be reused when prompt programmers are developing their prompt (e.g., “in the style of Pablo Picasso”, “detailed and complex, hyperrealistic”, “DSLR 35 mm”, etc.). The reusable phrases may be referred to as “prompt components”. The prompt components may be surfaced as suggested prompt components to users based on the context of their existing prompt. The interaction can help users to discover effective prompt components they may not have been aware of previously.

Components for artistic styles and different types of composition based on keywords in the prompt that the user has typed may be learned and/or stored. The components can be prepended (e.g., “Hyperrealistic isometric miniature”) and/or appended (“in the style of Henri Matisse”) depending on the component.

The prompt templates may include suggested prompts that act as a starting place when developing a new prompt. When new users first attempt prompt programming, prompt creation can take time and a significant amount of experimentation to discover how to write effective prompts. Prompt templates can include editor snippets with complete prompts that give users a starting point to work from. The templates can include editable regions to the template specification allowing templates to be generalized.

Surfacing the initial set of prompt template suggestions can be based on the user, the generative model, the context, and/or one or more settings. In some implementations, the user may write a brief description of what they are trying to accomplish, and then the systems and methods may use the language model to surface the appropriate categories of templates that should be displayed based on that input. Additionally and/or alternatively, the systems and methods may source template suggestions from prompt programmers.

The displayed tokenization can include in-context visualization of how the prompt will be tokenized when the prompt is passed to the generative model (e.g., a large language model).

Displaying how the model tokenizes the input prompt can enable the language model to be more understandable and can help the user to debug common issues (such as whitespace at the end of the prompt affecting the prompt's performance). Displaying the token boundaries dynamically as the user is typing their prompt can provide real time feedback to a user. Displaying whitespace annotations can help users understand how whitespace is included in the prompt's tokens. In order to understand how variables affect the tokenization, the systems and methods can extend the variable syntax to allow for an initial test example to be specified with the variable, and the systems and methods can color and/or underline the prompt content such that content that won't be present in the final prompt sent to the model has lower salience.

The user may insert a test value for variables and can therefore be provided the tokenization with content substituted into the variable. The process may not strictly be necessary in cases when the variable is bounded by whitespace. In some implementations, a text tokenizer may be utilized to verify if replacing whitespace delimited sections of sentences affects the tokenization before and/or after the replaced section.

The autocomplete feature can include predicting and providing sentence and/or prompt autocompletion suggestions and may be based on processing with a large language model (e.g., the generative model). The large language model may be used directly in the prompt programming experience to make inline autocomplete suggestions. Inline suggestions may be generated automatically as the user types by prompting the language model with the current prompt text. Additionally and/or alternatively, inline suggestions may be generated based on a request from the user. The interaction can support cycling through the set of suggestions returned from the model. In some implementations, suggestions can be guided by user input and/or context (e.g., the user can supply a natural language description of their goals for the prompt and that could be used to generate the suggestions).

The programmer input, the existing prompt content, and/or a set of macros can be designed to help programmers write effective prompts (e.g., macros to generate macros).

The prompt feedback interfaces can include an interface portal for receiving feedback from users. For example, a user may select a particular piece of text and have a mini-prompt to change the particular piece in place while also keeping the context intact.

When a user tries a prompt and gets an output, there can be cases when the output is not exactly satisfactory to the user. In such cases, the users may desire to have the ability to select parts of text, give a “feedback” which can then act as a “prompt” to correct that specific part of the output and keep the rest of the context intact without any modification. The prompt generation and viewing interface may be effective at modifying pieces of information while keeping the rest of the context intact.

The pattern recognition and suggestion can include suggesting prompts that act as a starting place when developing a new prompt. Few-shot prompts can include an optional preamble and then a set of repeating inputs and outputs in order to condition the language model on the expected output structure and content. Given this repeated structure, the systems and methods can support prompt programmers in the editing experience by automatically inserting snippets to continue the pattern as they add additional examples.

Additionally and/or alternatively, the systems and methods can leverage the language model to suggest potential examples to add to the prompt to further simplify the programming experience.

The prompt reformulation can include reformulating the input text (e.g., the prompt) based on a learned structure and/or based on an outcome that does not meet a given criteria.

When a prompt is not effectively solving the problem the prompt was written to solve, the systems and methods may rephrase a programmer's prompt. The rephrasing may use macros in conjunction with natural language input from the programmer (e.g., specifying what they are attempting to accomplish with the prompt) to generate reformulations. The systems and methods may validate suggested reformulations before proposing them to the programmer based on historical data and/or test data.

In some implementations, the systems and methods may learn from previous successful prompts. For example, a database of successful prompts can be leveraged for analogous input prompts. A simple end-to-end approach may include “User enters (to-be-revised) prompt→Search and retrieve similar successful prompts→reformulate current prompt→Better output”. The search criteria to retrieve prompts can be based on a learned embedding space, labels, key word search, feature search, etc. Reformulation can include prompt rewriting and/or parameter adjustment.

Alternatively and/or additionally, direct intervention on the prompt can be utilized using text modification, which may be based on feedback from the model to modify the prompt.

The error recognition can include processing the input text and/or the refined prompt to determine a potential source of suboptimal results, which may be indicated and/or resolved.

The integrated development environment may surface warnings of unintended behavior based on static analysis and/or based on running the prompt on test data and analyzing the result. For example, prompt programming interfaces may evaluate the prompt as the programmer is developing the prompt and may warn the programmer where the prompt may have unintended results. The recognition and notification may include warning the programmer when their prompt will likely generate harmful or biased output (e.g., test the prompt and flag output that triggers safety filters). The warnings may indicate which part of the prompt is potentially causing the issue (e.g., is the problem in the framing in the preamble or in one or more of the provided examples, etc.), and the warning may surface best practices and/or suggested remediation strategies. Additionally and/or alternatively, the systems and methods may surface potential responsible AI issues to prompt programmers directly in the prompting interface.

The snippet library may be utilized to store particular user snippets and/or global snippets and may be used as a database for prompt term suggestion.

The systems and methods may allow prompt programmers to save and share the prompts they develop. The user interface may include interface features for users to save, share, and lookup prompt snippets and complete prompts that are directly integrated into the prompt programming experience.

The expressive prompt language can include an expanded prompt programming language that supports detailed documentation, rich IDE support, and efficient reproducibility. The prompt-generation markup language may allow users to write using an easy-to-read, easy-to-write plain text format, and then get prompt-editing support through interface tools.

The prompt-generation markup language can include (1) a plain text formatting syntax—that helps prompt writers write more “legible” prompts; and (2) a software tool that parses the format to help with prompt “linting” or other suggestions (e.g., few-shot example completion, instruction rephrasing, snippet suggestions, etc.).

The systems and methods disclosed herein can enable efficient prompt generation that reduces the time and computational cost involved in the repetitive entry of prompts until the generative model generates a desired output. The systems and methods can utilize heuristics and/or one or more machine-learned models to determine the semantic structure of a preliminary prompt input. Based on the semantic structure, a determined task, historical data, stored templates, stored effective prompts, and/or the contents of the text, template suggestions, autocompletion suggestions, and/or structure suggestions can be determined and provided to the user to aid in prompt generation.

In some implementations, the systems and methods disclosed herein can interface with a plurality of different generative models and/or may be model specific. The systems and methods may process the text of a user input, provide suggestions, receive suggestion selections, provide token indicators, structure indicators, and may output data descriptive of a text prompt, a prompt embedding, and/or a multimodal prompt.

The systems and methods can leverage heuristics, machine-learned model(s), indexes of prompt templates, user data, historical data, stored effective prompts, and/or sequence prediction to provide informed suggestions that have improved efficiency when processed by a generative model.

The systems and methods can include iterative suggestions. For example, a prompt template can be suggested and selected. The systems and methods can then provide suggestions for autocompleting the placeholders of the template. The heuristic based suggestion can be based on the determined template, the determined prompt structure, and/or other data.

Additionally and/or alternatively, the systems and methods can enable a user to input temperature parameters that can be processed by the generative model to condition the response generated by the generative model. The temperature parameters can be descriptive of a temperature setting associated with how frequently a rarer term and/or phrase may be utilized in generating the output.

The systems and methods of the present disclosure provide a number of technical effects and benefits. As one example, the system and methods can provide an interface for receiving a user prompt request and outputting a refined prompt for prompting a generative model. In particular, the systems and methods disclosed herein can leverage a specialized markup language to transform a user input into a refined prompt of a given structure, wording, and/or weighting that matches a user intent, which can generate a more refined generative output when processed by a generative model.

Another technical benefit of the systems and methods of the present disclosure is the ability to leverage the specialized markup language interface to provide user interface tools and elements to provide annotations, indicators, and/or editing options to users to aid in the prompt generation. The user interface elements can inform users of how a prompt is interpreted, processed, and/or flawed. The editing options can allow users to adjust parameters, weights, wording, templates, and/or tokenization.

Another example of technical effect and benefit relates to improved computational efficiency and improvements in the functioning of a computing system. For example, the systems and methods disclosed herein can leverage the prompt-generation markup language interface to reduce the computational costs of iteratively refining prompts due to a lack of knowledge in prompt crafting. Additionally and/or alternatively, the prompt-generation markup language interface can provide prompt template suggestions, prompt term suggestions, prompt linting, and/or prompt condensing to generate a refined prompt that may be less computationally expensive to interpret with the generative model.

With reference now to the Figures, example embodiments of the present disclosure will be discussed in further detail.

### Example Devices and Systems

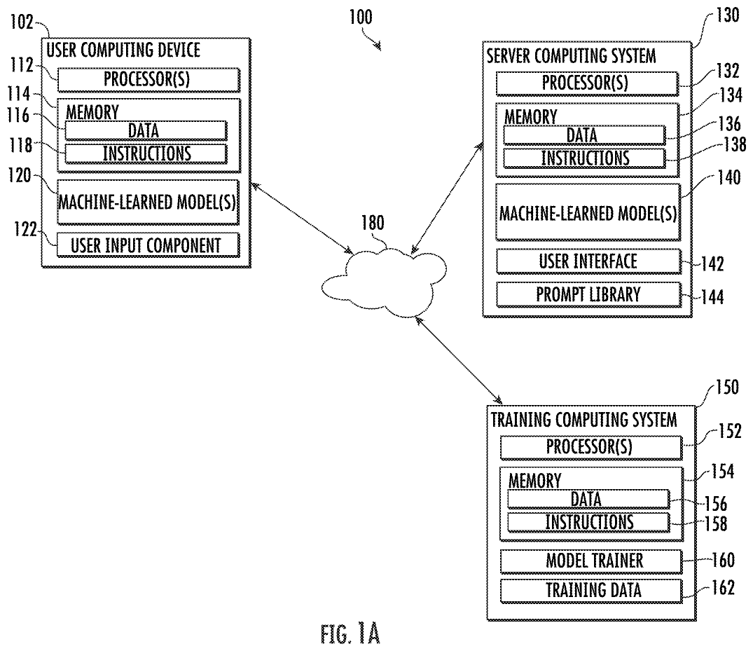

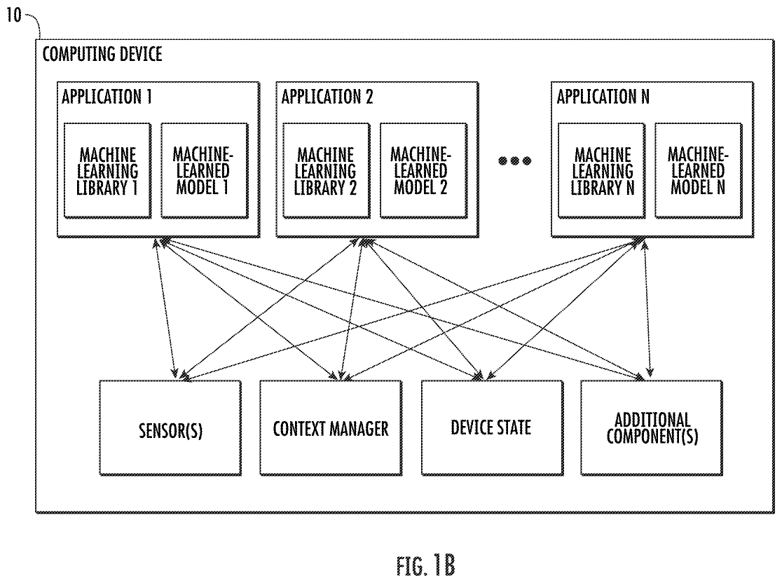

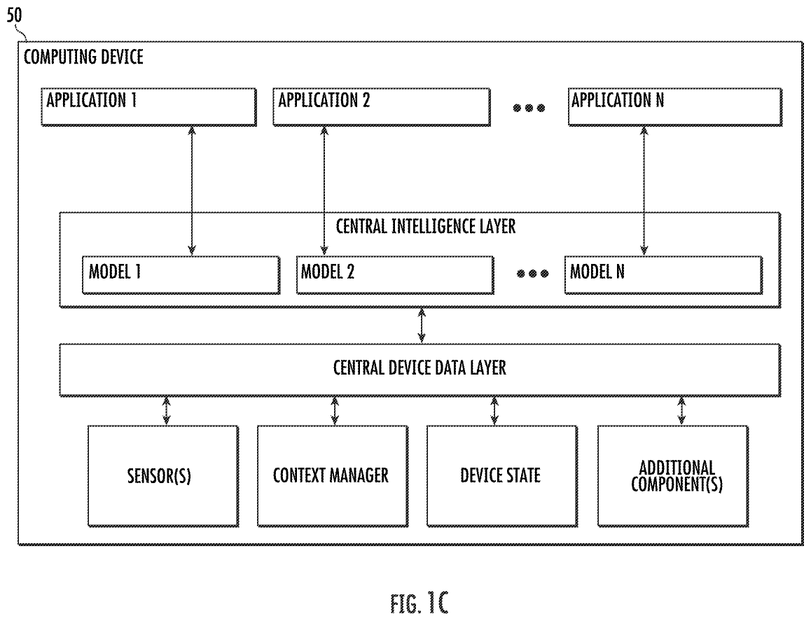

FIG. 1A depicts a block diagram of an example computing system 100 that performs prompt generation according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

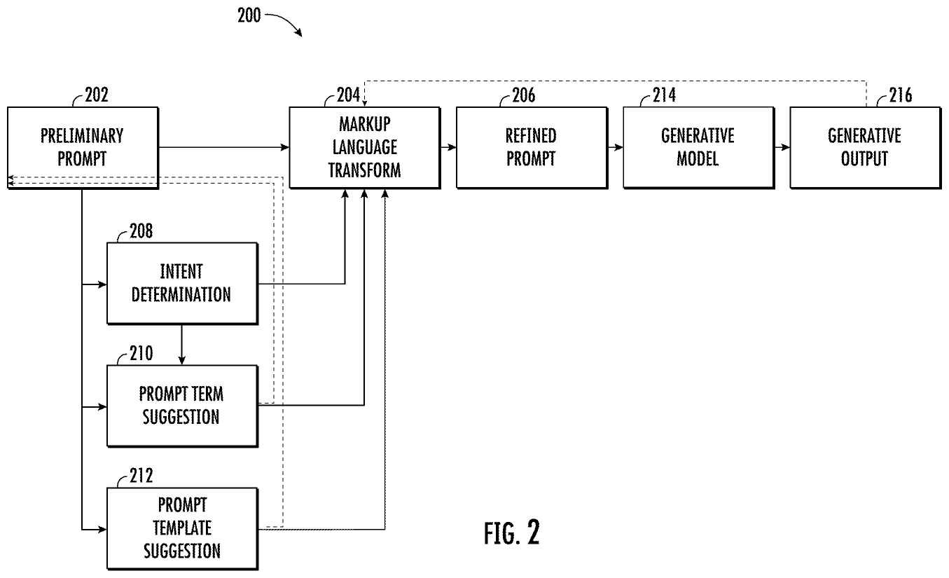

In some implementations, the user computing device 102 can store or include one or more generative models 120. For example, the generative models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example generative models 120 are discussed with reference to FIGS. 2-5 & 9-12.

In some implementations, the one or more generative models 120 can be received from the server computing system 130 over network 180, stored in the user computing device memory 114, and then used or otherwise implemented by the one or more processors 112. In some implementations, the user computing device 102 can implement multiple parallel instances of a single generative model 120 (e.g., to perform parallel prompt generation across multiple instances of prompt requests).

More particularly, the generative model 120 can be trained to process a prompt and generate content based on the prompt. The content can include text (e.g., a response to a question in the prompt), one or more images, one or more audio files, and/or other content. The generative model 120 can include a large language model and/or a text-to-image model. In some implementations, the language model can additionally be utilized for tokenization determination, autocompletion, template generation, and/or prompt term suggestions during the prompt crafting process.

Additionally or alternatively, one or more generative models 140 can be included in or otherwise stored and implemented by the server computing system 130 that communicates with the user computing device 102 according to a client-server relationship. For example, the generative models 140 can be implemented by the server computing system 140 as a portion of a web service (e.g., a prompt generation service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned generative models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2-5 & 9-12.

The server computing system 130 may include, store, and/or access a user interface 142 that can be utilized to interface with one or more users. The user interface 142 can be utilized to obtain inputs from the user and may be utilized to provide outputs for display. The user interface 142 may include an integrated development environment interface for prompt-generation markup language utilization.

Additionally and/or alternatively, the server computing system 130 can include, store, and/or access a prompt library 144, which can include an index of prompt terms, a prompt template database, and/or historical data associated with previous interactions by a plurality of users. The prompt library 144 can be accessed to obtain prompt term suggestions, prompt template suggestions, and/or for autocompletion.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the generative models 120 and/or 140 based on a set of training data 162. The training data 162 can include, for example, example prompts, example templates, example language data, example image data, example labels, example tokens, and/or term replacements.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired

functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP. SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable and/or efficient transmission or storage (and/or corresponding decoding). The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model and Interface Arrangements

FIG. 2 depicts a block diagram of an example prompt generation 200 based on markup language transform according to example embodiments of the present disclosure. In particular, input data can be obtained from a user (e.g., a plurality of input characters descriptive of a prompt request (e.g., a preliminary prompt 202)). The input data can include a preliminary prompt 202 provided by the user. The preliminary prompt 202 can include a natural language prompt. The preliminary prompt 202 can be processed to perform a markup language transform 204 to generate a refined prompt 206. The refined prompt 206 can include a particular structure, particular syntax, and/or particular wording. The particular structure, particular syntax, and/or the particular wording may be based on structure, syntax, and/or wording determined to be useful for generative model 214 prompting.

In some implementations, the preliminary prompt 202 can be processed by one or more machine-learned models to determine an intent of the prompt request. For example, the intent determination 208 can include processing with one or more natural language models, one or more semantic analysis models, and/or one or more sentiment analysis models. The determined intent can be utilized to generate the refined prompt 206. Additionally and/or alternatively, the determined intent can be utilized for prompt term suggestion 210. For example, the intent determination 208 can occur and then be utilized to determine one or more prompt term suggestions 210. The suggested prompt terms may be determined based on one or more machine-learned models (e.g., one or more language models (e.g., the generative model 214)). Alternatively and/or additionally, the suggested prompt terms may be based on a determined context, historical user data, and/or based on an index of prompt terms. The prompt term suggestion 210 can occur in real time, while the inputs text into an integrated development environment interface. The prompt term suggestions 210 can be utilized to generate the preliminary prompt 202 and/or to generate the refined prompt 206.

Additionally and/or alternatively, the preliminary prompt 202 and/or the refined prompt 206 may be generated based on a prompt template. The prompt template may be suggested 212 based on a type of model, a type of task, a determined intent, an input of a user, context data, and/or historical data. The prompt template suggestion 212 may be based on known successful prompts and/or training prompt template examples from a training dataset of the generative model 214.

Once the refined prompt 206 is generated, the refined prompt 206 may be provided to a user and/or may be provided to a generative model 214 to be processed to generate a generative output 216. The generative model 214 can include one or more transformer models, may include one or more autoregressive language models, and/or may include one or more stable diffusion models. The generative output 216 may include text data, image data, audio data, latent encoding data, and/or statistical data.

The generative output 216 may be processed to evaluate the success of the refined prompt 206. In some implementations, one or more parts of the refined prompt 206 may be adjusted (manually and/or automatically) based on the generative output 216. The adjusted prompt may then be processed by the generative model 214 to generate an adjusted output.

A user interface may be utilized to receive feedback from the user and/or to provide an interface for editing the prompts and/or for editing the outputs.

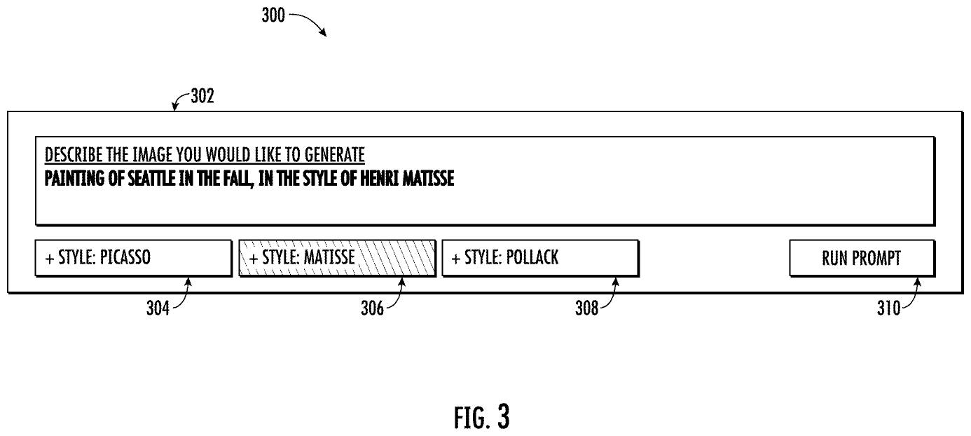

FIG. 3 depicts an illustration of an example prompt term suggestion interface 300 according to example embodiments of the present disclosure. In particular, the prompt term suggestion interface 300 can be configured to receive text from a user via a text input box 302 (e.g., a workspace of an integrated development environment). Instructions may be provided inside of, adjacent to, and/or in front of the text input box 302. The text input into the text input box 302 may be processed to determine an intent, a genre, a task, and/or a topic associated with the prompt request. The intent, the genre, the task, and/or the topic may be utilized to determine one or more prompt term suggestions. The prompt term suggestions can then be provided as selectable user interface elements that a user can select to add the term to the prompt. For example, the input text can include the term “painting”, which may trigger the suggestion of types of painting styles, which may be associated with a time period and/or an artist. The suggestions may be based on historical user data, heuristics, and/or index mapping. The suggestions may include Picasso, Matisse, and Pollack. The prompt term suggestion interface 300 can therefore provide a “Picasso” suggestion interface element 304, a “Matisse” suggestion interface element 306, and a “Pollack” suggestion interface element 308. The suggestions may include labels associated with a classification of the term type. For example, subject, detail, style, theme, color, and/or tone may be indicated, which may indicate how the term affects the prompt interpretation. In particular “Subject: Picasso” may produce an image of Picasso, while “Style: Picasso” may produce an image rendering of a painting in Picasso's art style.

In the depicted example, the “Matisse” suggestion interface element 306 is selected, and the terms “in the style of Henri Matisse” are added to the text input box 302. A user may then select a “run prompt” interface element 310 to have the prompt processed by a generative model to generate a generative output and/or to run diagnostics on the prompt to determine potential issues.

Alternatively and/or additionally, prompt term suggestions may include and/or may be denoted as component suggestions. For example, the systems and methods can generate predicted suggestions that may suggest a component (e.g., for artistic styles and different types of composition based on keywords) for a prompt typed by the user. The prompt components may be either prepended (e.g., “Hyper Realistic isometric miniature”) or appended (“in the style of Henri Matisse”) depending on the component.

Prompt components may be short phrases (e.g., “in the style of Pablo Picasso”, “detailed and complex, hyperrealistic”, “DSLR 35 mm”, etc.) that are frequently reused by the prompt programmers when they are developing their prompts.

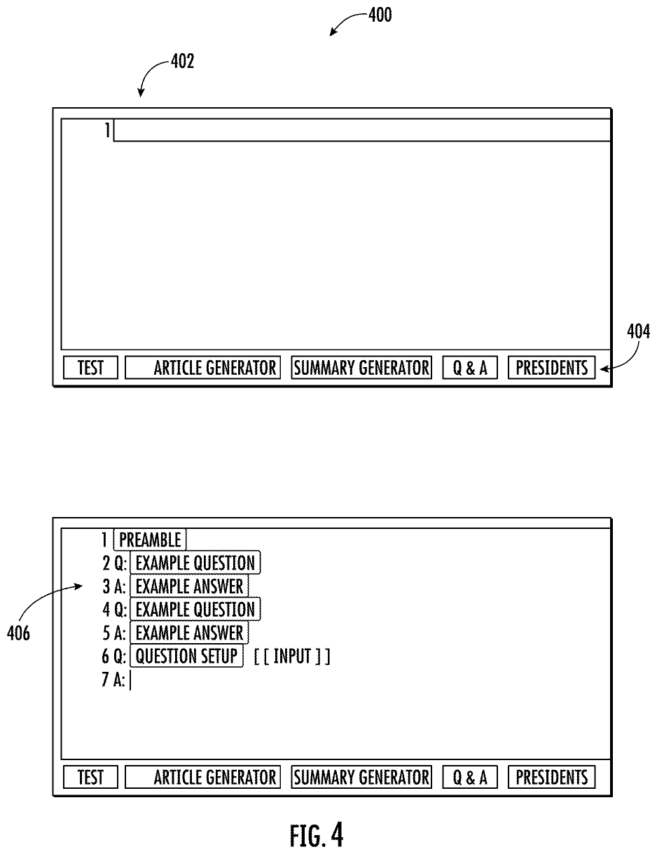

FIG. 4 depicts an illustration of an example prompt template interface 400 according to example embodiments of the present disclosure. In particular, the prompt template interface 400 can include an integrated development environment 402 for receiving inputs and may include selectable tasks and/or topics chips 404 that may be pre-associated with one or more particular prompt templates. For example, a “Q&A” interface chip may be selected. In response to the selection, a prompt template 406 may be provided. The prompt template 406 depicted includes a plurality of input areas and indicators with instructions for formatting the input. In some implementations, the prompt template 406 may include examples, a dropdown of selectable options, prompt term suggestions, and/or iteratively updating templates.

In some implementations, the prompt template interface 400 can provide a prompt template (i.e., an editor snippet with complete prompts) that give users a starting point to work from and can extend the prompt templates by adding editable regions to the template specification.

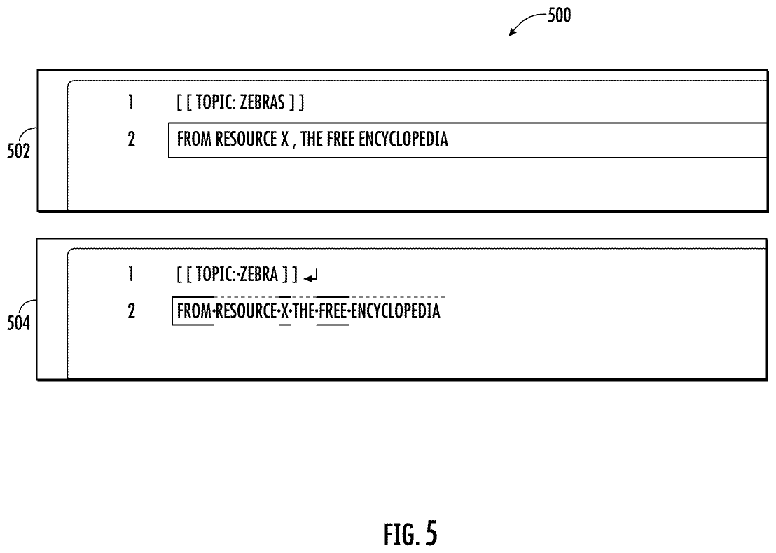

FIG. 5 depicts an illustration of example token indicators 500 according to example embodiments of the present disclosure. In particular, a user may provide a preliminary prompt 502, which may include a mix of natural language and specialized markup language syntax. The preliminary prompt 502 can be processed to determine processing tokens for the preliminary prompt 502, which may include tokenizing the text based on semantic analysis, separators, syntax, and/or delimiters. The tokens can then be indicated via a plurality of token indicators 504, which may include color indicators, symbol indicators, highlighting indicators, and/or other types of indicators. The plurality of token indicators 504 can inform a user of how the preliminary prompt 502 may be processed. For example, if cohesive terms are identified as separate tokens, a user may adjust the syntax and/or wording of the prompt.

In particular, the systems and methods disclosed herein can display how the generative model (e.g., the language model) is tokenizing the input prompt to (i) make the language model more understandable, and (ii) help the user to debug common issues (e.g., whitespace at the end of the prompt affecting the prompt's performance). For example, the example depicted in FIG. 5 displays the token boundaries dynamically as the user is typing their prompt. In order to understand how variables affect the tokenization, the example token indicator system can extend the variable syntax to allow for an initial test example to be specified with the variable and can color and/or underline the prompt content such that content that won't be present in the final prompt sent to the model has lower salience.

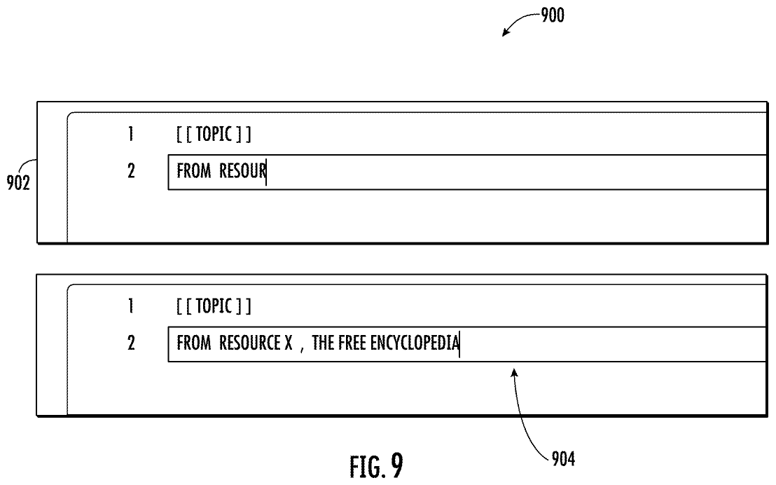

FIG. 9 depicts an illustration of an example autocompletion suggestion 900 according to example embodiments of the present disclosure. In particular, a set of input characters may be received and provided for display in an integrated development environment interface 902. The set of input characters may be processed to determine a prediction for the input (e.g., an autocompletion prediction). Based on the prediction, an autocompletion interface clement 904 may be provided for display. The autocompletion interface element 904 can include text in a different color and/or in a different format. The autocompletion interface element 904 may be provided inline with the input text, may be provided in a pop-up, may be provided in a drop-down menu, and/or may be provided via one or more interface chips.

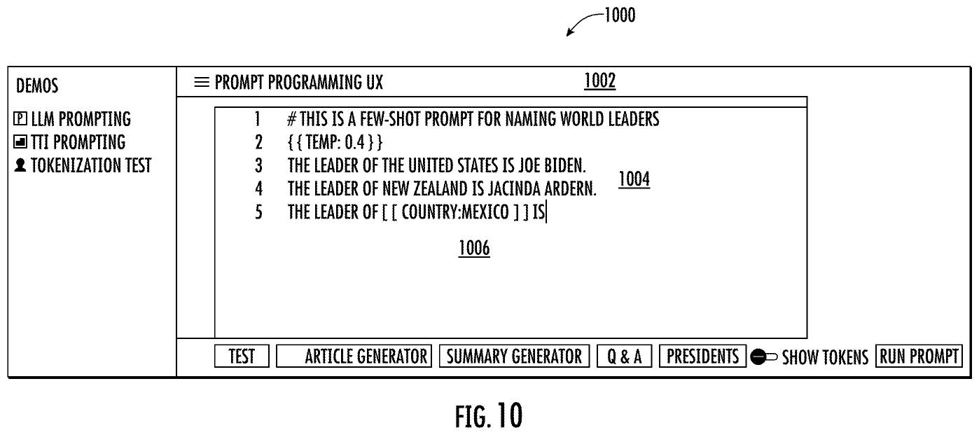

FIG. 10 depicts an illustration of an example prompt writer interface 1000 according to example embodiments of the present disclosure. In particular, the prompt writer interface 1000 can include an integrated development environment 1002 for a specialized prompt markup language. The specialized markup language can include plain text formatting syntax that helps a prompt writer to write legible prompts. Additionally and/or alternatively, the prompt writer interface 1000 can include one or more software tools to parse the plain text format to help with prompt linting (i.e., correcting possible problems) and/or other suggestions (e.g., few-shot example completion, instruction rephrasing, snippet suggestions, etc.).

The systems and methods disclosed herein can detect where an example starts and ends, can suggest a next example template (e.g., when the user types \hat{ }\* again), and can sanitize the output to acceptable values. Additionally and/or alternatively, the systems and methods can provide instructional hints (e.g. your instruction ends with a space, remove it) and may index the prompts. In some implementations, the systems and methods can document (and/or index) prompts with an explanation of the prompt and its intended inputs and output, and a model and the parameters that were used to develop the prompt.

Additionally and/or alternatively, the prompt writer interface 1000 and/or the specialized markup language can be leveraged to provide features for adding comments (e.g., comments that do not affect the prompt (e.g., the comment line begins with a hash “ #” symbol that allows prompt programmers to document their prompts and provide context to others who may read or reuse their prompts)), adding parameter specifications that allow prompt programmers to specify the model and parameters of the model that they used when developing the prompt (e.g., {{ model: meena-glm, temp: 0.4}} indicate that the prompt programmer developed and tested this prompt with the LaMDA-generalized linear model (GLM) using a temperature parameter set to 0.4)), adding variables that allow users to specify where the input values should be merged with the prompt before being passed to the language model (e.g., [[input: example input value]] allow the prompt programmer to specify a test example directly in the prompt, adding context and making the variable more understandable), and/or adding application programming interface (API) calls that allows API calls to be directly integrated into prompts and allows the prompts to evolve over time (e.g., ((lookupCurrent Weather(Seattle).isOvercast))).

In particular, the prompt writer interface 1000 can receive inputs 1004 in an integrated development environment 1002, which may include natural language text strings for prompting, comments for programmer notes, and/or parameter specifications for facilitating processing. The inputs 1004 may be processed to determine a pattern, which can be utilized to suggest a prompt template 1006.

Additionally and/or alternatively, the prompt writer interface 1000 can provide few-shot continuation support by automatically inserting snippets to continue a pattern (e.g., a determined pattern that may include a preamble and a set of repeating inputs and outputs) and suggesting potential examples to add to the prompt when the programmers add additional examples. The prompt writer interface 1000 may rephrase the user's prompt using macros in conjunction with natural language input from the user (or programmer). In some implementations, the prompt writer interface 1000 may expose more of the internals (e.g., token embeddings) of the language models to the user to give advanced control over the behavior of their prompt. Additionally and/or alternatively, the prompt writer interface 1000 may create a prompt/snippet library for users to save, share, and/or lookup prompt snippets and complete the prompts.

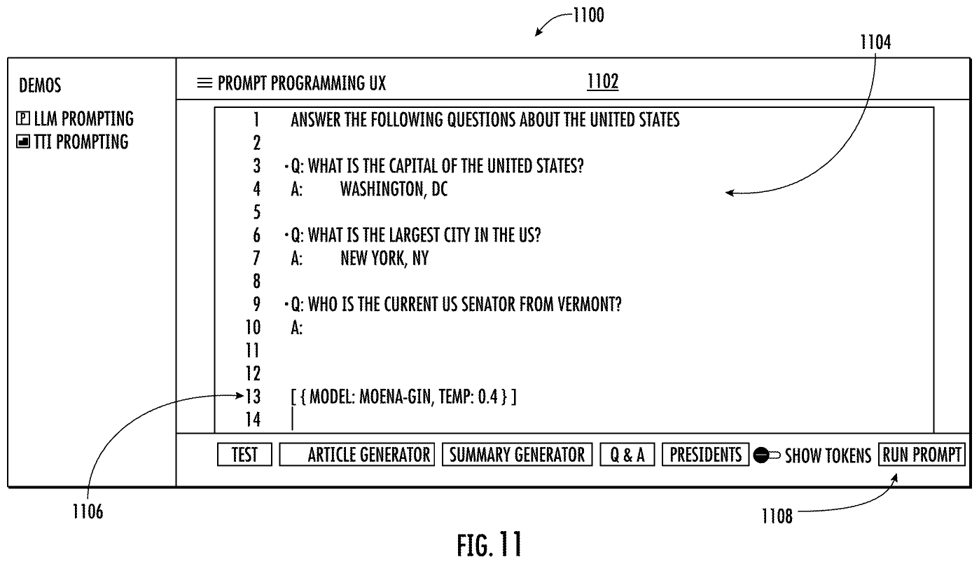

FIG. 11 depicts an illustration of an example prompt programming user interface 1100 experience according to example embodiments of the present disclosure. The prompt programming user interface 1100 can include an integrated development environment 1102 that can receive inputs 1104 & 1106, which may include language inputs 1104 (e.g., freeform text inputs, prompt component suggestion selections, and/or template selections). The language inputs 1104 can be displayed in the prompt programming user interface 1100. Additionally and/or alternatively, the prompt programming user interface 1100 may be configured to receive parameter specification inputs 1106, which may specify a model to utilize, parameters to utilize, and/or iterations of generation. When the “run prompt” interface element 1108 is selected, the prompt programming user interface 1100 can process the language inputs 1104 and the parameter specification inputs 1106 can be processed to generate a refined prompt for the prompt request that may be utilized to obtain and/or configure a generative model that meets the criteria of the parameter specification inputs 1106. The generative model can then process the data descriptive of the language inputs 1104 to generate a generative output.

If the generative output is not satisfactory to the user, the prompt programming user interface 1100 may enable the user to select parts of the text, give “feedback” which can then act as a “prompt” to correct that specific part of the output, and/or keep the rest of the context in-tact without any modification. The interaction can be utilized to adjust the prompt (and perform an additional generation cycle) and/or to adjust the generative output.

In some implementations, the prompt programming user interface 1100 may evaluate the prompt as the programmer is developing the prompt and may warn the programmer when the prompt is likely to generate unintended results. For example, the warnings can include notifications warning the programmer when their prompt will likely generate harmful and/or biased outputs (e.g., may test the prompt and flag outputs that trigger safety filters). The warnings may indicate which part of the prompt is potentially causing the issue (e.g., is the problem in the framing of the preamble and/or in one or more of the provided examples, etc.) and surfaces best practices and/or suggested remediation strategies.

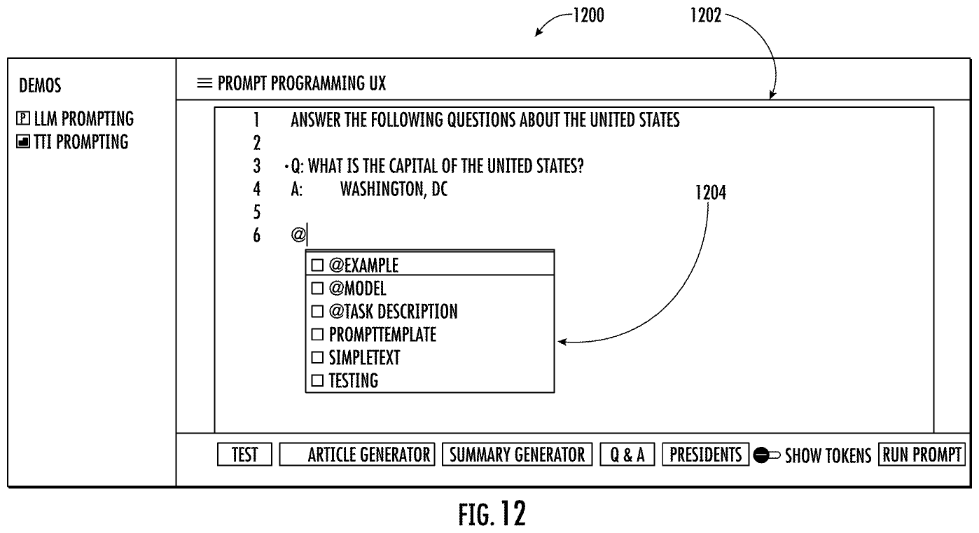

FIG. 12 depicts an illustration of an example dropdown interface element 1200 according to example embodiments of the present disclosure. In particular, the systems and methods disclosed herein can leverage a plurality of different interface element features to provide an interface for crafting prompts. One such interface element feature may include a dropdown interface element 1200. For example, a user may provide inputs to an integrated development environment 1202 and may input an operator that triggers the providing of a dropdown menu 1204, which may include options for examples, model selection, task descriptions, prompt templates, simple text, and/or testing.

### Example Methods

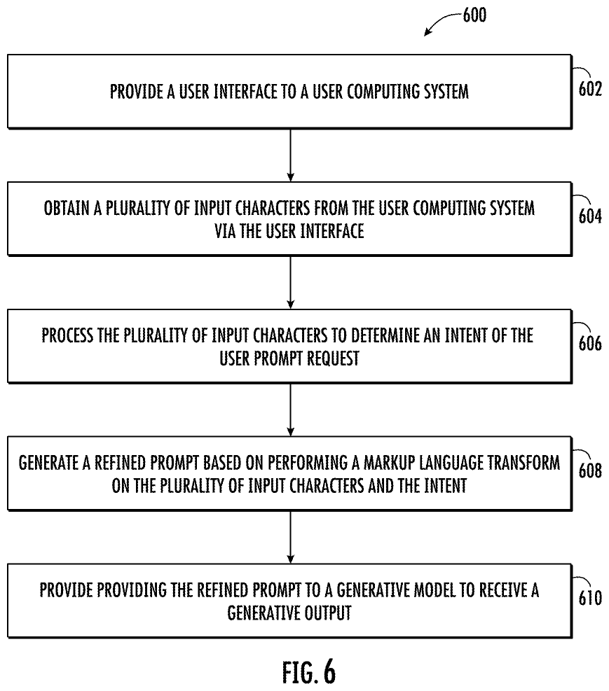

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can provide a user interface to a user computing system. The user interface can include an integrated development environment. The integrated development environment can be configured to receive a plurality of input characters. Additionally and/or alternatively, the integrated development environment can be configured to perform the markup language transform. In some implementations, the integrated development environment can be associated with prompt-generation markup language. The prompt-generation markup language can include one or more delimiters selected to differ from a symbol utilized in traditional natural language usage. Additionally and/or alternatively, the integrated development environment can be associated with a text-encoding system associated with a set of pre-determined symbols associated with a set of formatting operators.

At 604, the computing system can obtain a plurality of input characters from the user computing system via the user interface. The plurality of input characters can be descriptive of a user prompt request. The plurality of input characters can be descriptive of a natural language text string. Alternatively and/or additionally, the plurality of input characters can include one or more syntax symbols. The syntax symbols may be associated with functions of the prompt-generation markup language and/or may be natural language syntax that may denote traditional syntactical use. In some implementations, the plurality of input characters can be descriptive of a plurality of words and/or a plurality of separators (e.g., spaces, commas, periods, slashes, etc.).

At 606, the computing system can process the plurality of input characters to determine an intent of the user prompt request. The processing can include parsing the plurality of input characters to segment one or more words, one or more phrases, and/or one or more other text string segments. The parsed segments may be processed to determine individual segment intents. The individual segment intents can then be processed to determine an overall intent. Alternatively and/or additionally, the plurality of input characters may be processed as a whole to determine the intent. In some implementations, one or more other processing techniques may be utilized to determine intent. Intent determination can include processing with one or more models (e.g., a semantic understanding model, a segmentation model, a detection model, a sentiment model, and/or a classification model). The intent can be descriptive of a genre, a type of creation, a central thesis of the prompt request, and/or a purpose of generation.

At 608, the computing system can generate a refined prompt based on performing a markup language transform on the plurality of input characters and the intent. In some implementations, the refined prompt can include a preamble associated with a specified task. The refined prompt may include a body associated with one or more details to include in the generative output. In some implementations, the refined prompt can include weights, a specific structure associated with a subject and one or more details, and/or one or more parameters for selecting a particular model, a particular temperature, and/or a particular template.

At 610, the computing system can provide the refined prompt to a generative model to receive a generative output. The generative model can include one or more transformer models. The generative model can include a stable diffusion model and/or an autoregressive language model. In some implementations, the generative model can be trained to process a prompt and generate one or more content outputs. The one or more content outputs can include text (e.g., a natural language response), one or more images (e.g., a generated image of the described prompt), an audio file, a video, statistical data, latent encoding data, and/or other signal data.

In some implementations, the computing system can receive the generative output from the generative model and provide the generative output to the user computing system. The generative output may be displayed in the user interface. The generative output may be provided in a preview window of the integrated development environment, in line and/or following the prompt in the integrated development environment, and/or in a separate window. In some implementations, the generative output may be provided with an annotated refined prompt and/or an annotated plurality of input characters. The annotations can be descriptive of tokenization, determined intent, usage of the characters, and/or one or more options for editing. In some implementations, the generative output may replace the integrated development environment.

Additionally and/or alternatively, the computing system can process the plurality of input characters to determine a plurality of text tokens associated with a plurality of input character sets determined to be semantically linked and provide a plurality of respective token indicators associated with the plurality of text tokens. In some implementations, the text token determination can be performed by one or more machine-learned models (e.g., one or more language models (e.g., one or more natural language processing models), one or more segmentation models, and/or one or more semantic analysis models). Each respective token indicator can include a graphical indicator indicating a length and location of a respective text token. The one or more graphical indicators may be utilized to determine how the text string is processed and may be utilized for problem solving (e.g., determining that semantically linked words were not processed cohesively during the prompt processing (e.g., “snow crab” may have been processed as individual words instead of as a whole)).

In some implementations, the computing system can determine one or more prompt term suggestions based on the intent and can provide the one or more prompt term suggestions as selectable user interface elements. The one or more prompt term suggestions may be based on one or more natural language processing models processing the input characters to provide outputs descriptive of an autocompletion task and/or a semantic analysis task. The prompt term suggestions may be machine-learned model outputs and/or may be retrieved from an index of prompt terms. The index may be based on the training data of the generative model.

Alternatively and/or additionally, the index may be generated based on historical data associated with the generative model and/or the specific user. For example, terms that lead to a desired result may be determined and stored, while terms that may be determined as often replaced in iterative prompt inputs may be not included and/or may be annotated in the index to replace if provided by the user. The index may be based on past usage by the user and/or may be based on other user data (e.g., search history, browsing history, messaging history, user profile data, news proximate to the user, and/or predictive data associated with the user).

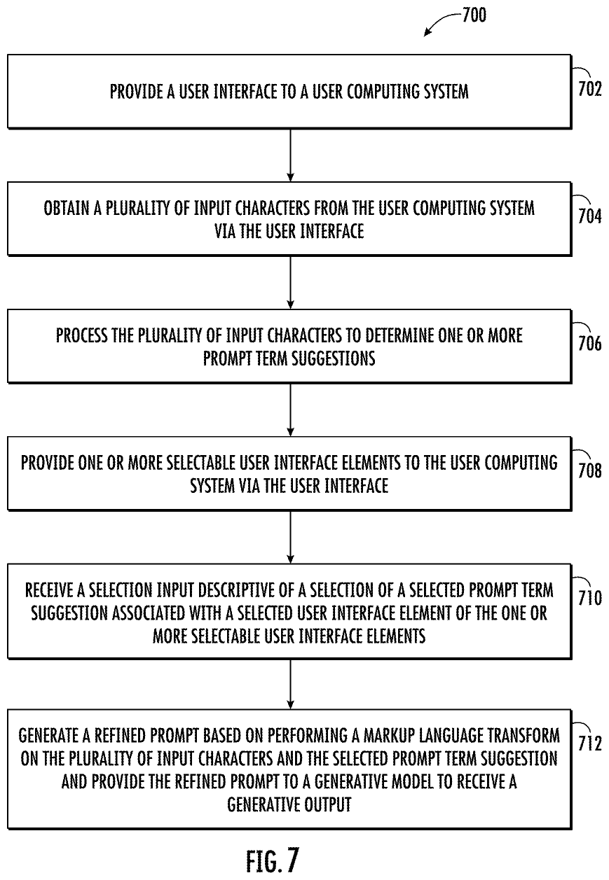

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can provide a user interface to a user computing system. The user interface can include an integrated development environment. The user interface can be configured to display input data, a generated refined prompt, one or more user interface elements (e.g., one or more indicators and/or one or more annotations), and/or one or more generative outputs. The user interface may include multiple display windows to display multiple content types. In some implementations, the integrated development environment can include line numbering, space formatting, color notations, drop-down windows, and/or a table of functions or operators.

At 704, the computing system can obtain a plurality of input characters from the user computing system via the user interface. In some implementations, the plurality of input characters can be descriptive of a user prompt request. The prompt request may be descriptive of one or more subjects (e.g., one or more environments and/or one or more objects) and/or one or more details for the one or more subjects (e.g., one or more descriptors, which can include adjectives, adverbs, genre descriptors, aesthetic descriptors, color descriptors, culture descriptors, etc.).

At 706, the computing system can process the plurality of input characters to determine one or more prompt term suggestions. The one or more prompt term suggestions can be determined based on a determined intent of the prompt request. The determined intent can be determined based on processing at least a subset of the plurality of input characters. In some implementations, the one or more prompt term suggestions can be obtained from an index of prompt terms. The index of prompt terms may have been generated based on historical prompt data associated with historical content generation. Alternatively and/or additionally, the index of prompt terms may have been generated based on one or more training labels associated with the training dataset for the generative model.

At 708, the computing system can provide one or more selectable user interface elements to the user computing system via the user interface. The one or more selectable user interface elements can be associated with the one or more prompt term suggestions. The one or more selectable user interface elements can include inline text and/or may be provided via a drop-down menu, a bubble, and/or a pop-up.

At 710, the computing system can receive a selection input descriptive of a selection of a selected prompt term suggestion associated with a selected user interface element of the one or more selectable user interface elements. The selection input can include a gesture input, a key selection (e.g., “tab”), a touch selection, and/or a mouse selection.

At 712, the computing system can generate a refined prompt based on performing a markup language transform on the plurality of input characters and the selected prompt term suggestion and provide the refined prompt to a generative model to receive a generative output. In some implementations, the plurality of input characters can include a first structure. The refined prompt can include a second structure. The generative model can include a text-to-text model, a text-to-image model, a text-to-audio model, and/or another generative model. The prompt request and/or the generative output may include multimodal data (e.g., text data, image data, and/or audio data).

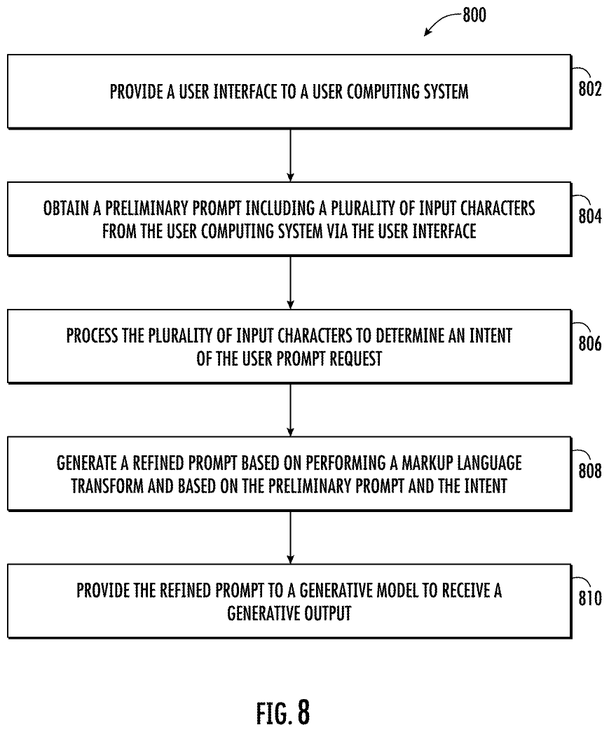

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can provide a user interface to a user computing system. The user interface can include an integrated development environment. The integrated development environment can be associated with a specialized markup language for prompt generation. The specialized markup language may be denoted as a prompt generation markup language. The specialized markup language can include delimiters that do not traditionally appear in natural language text strings. Additionally and/or alternatively, the specialized markup language can include operators that do not traditionally appear in natural language text strings. The specialized markup language can include operators for separation, weighting, classification, notification, parameter specification, and/or priority notations.

At 804, the computing system can obtain a preliminary prompt including a plurality of input characters from the user computing system via the user interface. In some implementations, the plurality of input characters can be descriptive of a user prompt request. The plurality of input characters can be descriptive of a subject and one or more details to include in a generated subject. The prompt request can be associated with a specific generative model, a specific temperature, a specific genre, a specific parameter setting, a specific use or vocabulary, and/or a specific particularity.

At 806, the computing system can process the plurality of input characters to determine an intent of the user prompt request. The intent can be determined based on a top-down approach, a bottom-up approach, a series processing of the individual parts and the whole simultaneously, and/or context data. The intent can be descriptive of a theme, genre, type of output, and/or an overall environment.

At 808, the computing system can generate a refined prompt based on performing a markup language transform and based on the preliminary prompt and the intent. In some implementations, the refined prompt can include a restructured text string descriptive of a predetermined style. Additionally and/or alternatively, the refined prompt can be descriptive of the subject and the one or more details. Generating the refined prompt can include word mapping. A subset of the plurality of input characters may be mapped to one or more alternate words. Additionally and/or alternatively, generating the refined prompt can include structure mapping. A subset of the plurality of input characters may be mapped to a predefined structure associated with a preamble and a body of the refined prompt.

At 810, the computing system can provide the refined prompt to a generative model to receive a generative output. The generative model can be a large language model and/or an image generative model. The generative output can include text data, image data, audio data, embedding data, video data, and/or multimodal data.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, the system comprising:
one or more processors; and
one or more non-transitory computer-readable media that collectively store instructions that, when executed by the one or more processors, cause the computing system to perform operations, the operations comprising:
providing a user interface to a user computing system, wherein the user interface comprises an integrated development environment;
obtaining a plurality of input characters from the user computing system via the user interface, wherein the plurality of input characters are descriptive of a user prompt request;
processing the plurality of input characters to determine an intent of the user prompt request;
generating a refined prompt based on performing a mark-up language transform on the plurality of input characters and the intent; and
providing the refined prompt to a generative model to receive a generative output.

2. The system of claim 1, wherein the operations further comprise:
receiving the generative output from the generative model; and
providing the generative output to the user computing system.

3. The system of claim 1, wherein the operations further comprise:
processing the plurality of input characters to determine a plurality of text tokens associated with a plurality of input character sets determined to be semantically linked; and
providing a plurality of respective token indicators associated with at least a subset of the plurality of text tokens, wherein each respective token indicator comprises a graphical indicator indicating a length and location of a respective text token.

4. The system of claim 1, wherein the integrated development environment is configured to receive the plurality of input characters and is configured to perform the mark-up language transform.

5. The system of claim 1, wherein the integrated development environment is associated with prompt-generation mark-up language.

6. The system of claim 5, wherein the prompt-generation mark-up language comprises one or more delimiters selected based on a determined low likelihood of use in traditional natural language.

7. The system of claim 1, wherein the integrated development environment is associated with a text-encoding system associated with a set of pre-determined symbols associated with a set of formatting operators.

8. The system of claim 1, wherein the refined prompt comprises a preamble associated with a specified task.

9. The system of claim 1, wherein the refined prompt comprises a body associated with one or more details to include in the generative output.

10. The system of claim 1, wherein the operations further comprise:
determining one or more prompt term suggestions based on the intent; and
providing the one or more prompt term suggestions as selectable user interface elements.

11. A computer-implemented method for prompt generation, the method comprising:
providing, by a computing system comprising one or more processors, a user interface to a user computing system, wherein the user interface comprises an integrated development environment;
obtaining, by the computing system, a plurality of input characters from the user computing system via the user interface, wherein the plurality of input characters are descriptive of a user prompt request;
processing, by the computing system, the plurality of input characters to determine one or more prompt term suggestions;
providing, by the computing system, one or more selectable user interface elements to the user computing system via the user interface, wherein the one or more selectable user interface elements are associated with the one or more prompt term suggestions;
receiving, by the computing system, a selection input descriptive of a selection of a selected prompt term suggestion associated with a selected user interface element of the one or more selectable user interface elements;
generating, by the computing system, a refined prompt based on performing a mark-up language transform on the plurality of input characters and the selected prompt term suggestion; and
providing, by the computing system, the refined prompt to a generative model to receive a generative output.

12. The method of claim 11, wherein the one or more prompt term suggestions are determined based on a determined intent of the prompt request, wherein the determined intent is determined based on processing at least a subset of the plurality of input characters.

13. The method of claim 11, wherein the one or more prompt term suggestions are obtained from an index of prompt terms.

14. The method of claim 13, wherein the index of prompt terms was generated based on historical prompt data associated with historical content generation.

15. The method of claim 13, wherein the index of prompt terms was generated based on one or more training labels associated with the training dataset for the generative model.

16. The method of claim 11, wherein the plurality of input characters comprise a first structure, and wherein the refined prompt comprises a second structure.

17. One or more non-transitory computer-readable media that collectively store instructions that, when executed by one or more computing devices, cause the one or more computing devices to perform operations, the operations comprising:
providing a user interface to a user computing system, wherein the user interface comprises an integrated development environment, wherein the integrated development environment is associated with a specialized mark-up language for prompt generation;
obtaining preliminary prompt comprising a plurality of input characters from the user computing system via the user interface, wherein the plurality of input characters are descriptive of a user prompt request;
processing the plurality of input characters to determine an intent of the user prompt request;
generating a refined prompt based on performing a mark-up language transform and based on the preliminary prompt and the intent; and
providing the refined prompt to a generative model to receive a generative output.

18. The one or more non-transitory computer-readable media of claim 17, wherein the plurality of input characters are descriptive of a subject and one or more details to include in a generated subject, wherein the refined prompt comprises a restructured text string descriptive of a predetermined style, and wherein the refined prompt is descriptive of the subject and the one or more details.

19. The one or more non-transitory computer-readable media of claim 17, wherein generating the refined prompt comprises word mapping, wherein a subset of the plurality of input characters are mapped to one or more alternate words.

20. The one or more non-transitory computer-readable media of claim 17, wherein generating the refined prompt comprises structure mapping, wherein a subset of the plurality of input characters are mapped to a predefined structure associated with a preamble and a body of the refined prompt.
